(19) United States
(12) Patent Application Publication
(10) Pub. No.: US 2010/0040832 A1
(43) Pub. Date: Feb. 18, 2010

(54) FORMALDEHYDE FREE WOVEN AND NON-WOVEN FABRICS HAVING IMPROVED HOT WET TENSILE STRENGTH AND BINDER FORMULATIONS FOR SAME

(75) Inventor: CHARLES G. HERBERT, Shrewsbury, MA (US)

Correspondence Address: DUANE MORRIS LLP - Philadelphia;IP DEPARTMENT, 30 SOUTH 17TH STREET, PHILADELPHIA, PA, 19103-4196, US

(73) Assignee: Saint-Gobain Technical Fabrics America, Inc.

(21) Appl. No.: 12/190,649

(22) Filed: Aug. 13, 2008

(51) Int. Cl. B32B 17/04; B32B 5/22; C08F 265/04

(52) U.S. Cl. 428/143; 428/426; 428/413; 264/128; 55/524; 428/343; 525/54.26; 525/307

(57) ABSTRACT

Glass mats for use in building construction are provided. The mats include chopped glass fibers and a formaldehyde-free-curable binder disposed on the glass fibers. The binder includes a binder selected from polyorganic acid-polyol, starch grafted acrylic styrene and acrylic modified polyvinyl acetate, for example, containing a sufficient amount of a hydrophobic additive to improve the hot wet retention of the mat after five minutes of exposure to 80° C. water by at least about 5%.

### FIELD OF THE INVENTION

This invention concerns formaldehyde free woven and non-woven fabrics, suitable for use in the construction of roofing mat, shingles, air filters, drywall tape, and cementitious boards.

### BACKGROUND OF THE INVENTION

Resin based binders for wet laid chopped glass fiber mat used in such things as roofing shingles and gypsum boards are conventionally prepared using urea formaldehyde (“UF”) binders. In some countries, growing environmental pressures are resulting in current or proposed legislation which may limit or eliminate formaldehyde emissions. Accordingly, there is a continued and growing need for compositions which do not emit formaldehyde.

A number of compositions for non-wovens which do not emit formaldehyde upon cross linking have been disclosed in the prior art. See, for example, U.S. Pat. No. 5,143,582; 6,734,237; 6,884,838; European Pat. No. EP 0405917 and U.S. Pat. Applications 2006/0292952 and 2007/0039703, which are all hereby incorporated by reference.

Formaldehyde free binder chemistry, based upon water-dispersed poly (acrylic acid) blended with polyol and an acid catalyst, has been marketed as an environmentally friendly alternative to urea formaldehyde. Acrylic/polyol-based non-woven mats tend to yield sufficient dry tensile strength, but often exhibit insufficient hot tensile strength, due to moisture sensitivity. The acrylic/polyol chemistry requires a much higher curing temperature in comparison to urea formaldehyde. Additionally, the acrylic/polyol binder is water sensitive if it is insufficiently cured during mat production as a consequence of the required higher curing temperature.

An important critical property for non-woven glass mat for roofing shingle reinforcement is the ability to retain tensile strength after exposure to 80° C. water. As shown in FIGS. 1-4, cross linked polyester binder is not water resistant with incomplete curing, often typical in plant manufacturing of non-wovens. Generally the tear strength and tensile strength of non-wovens made with formaldehyde free (“FF”) acrylic are within acceptable ranges for urea formaldehyde minimums and maximums. Nevertheless, non-wovens made with conventional FF acrylic fail in hot wet strength percent retention (hot wet retention=tensile strength of mat after five minutes exposure to 80° C. water×100%÷dry tensile strength).

The majority of commercially available formaldehyde free alternatives to urea formaldehyde binders are based upon polyacrylic acid blended polyol, typically triethanol amine. Such binders are not resistant to moisture and result in wet retention percentages of about 52% or less when used to bind non-woven glass mat hand sheets at 200° C. curing temperatures. Previous trials conducted by applicants for the acrylic/polyol binder (Aquaset 100) indicated low hot wet retention rates.

Accordingly, there remains a need for formaldehyde free non-woven mats which have improved hot wet tensile strength retention while maintaining adequate dry tensile strength and tear strength.

### SUMMARY OF THE INVENTION

In a first embodiment of this invention, a glass mat for use in building construction applications is provided. The mat includes chopped glass fibers and a formaldehyde free, curable binder disposed on said glass fibers. The binder comprises a starch grafted acrylic styrene binder composition, containing a sufficient amount of a hydrophobic additive to improve the hot wet retention of said mat by at least 5% after five minutes of exposure to water heated to 80° C.

The present invention discloses the addition of hydrophobic additives, and preferably, reactive hydrophobic additives, such as stearyl acrylates, stearyl melamines, epoxidized fatty acid based oils, such as soybean, and epoxy silanes, which, when added to the binder chemistries containing, for example, acrylic polyol, starch grafted styrene and acrylic modified polyvinyl acetate, results in the retention of sufficient dry tensile strength and significant improvements in hot wet tensile retention rates, preferably at least 5%, and more preferably, at least 10%, and most preferably, greater than 20%. The use of the disclosed formulation approaches yields non-woven mats with critical properties suitable for roofing shingle reinforcement, as well as for other products, such as air filters, drywall tape, and reinforcement facings for gypsum and cement-based boards.

The tensile strength of non-woven mat is required mainly during the manufacture of the mat, and particularly in the manufacture of roofing shingles. Sufficient strength is needed to pull the mat through the shingle manufacturing line over multiple rollers and accumulators. This tends to be more of an issue in a shingle plant where there is higher tension on the line. The mat is usually exposed to hot asphalt in the range of 350-450° F., and granules are pressed into the surface of the asphalt under pressure. The tensile strength of the non-woven mat in the machine direction needs to be high enough to prevent web breaks.

Urea formaldehyde binder is hydrophilic and loses strength when it is exposed to moisture, so guidelines have been set for hot wet retention for urea formaldehyde binder systems. The binder systems of the present invention are designed to meet or exceed these guidelines.

In a further aspect of a preferred method of this invention, a nonwoven glass mat is impregnated with asphalt. After passing through the asphalt coater, the asphalt is urged into the mat by exposure to hot steam jets. Hot wet tensile retention of the mat is required during this step. Hot wet tension retention is an asset in the roofing industry in other ways, since this measurement is considered a strong indicator of long-term environmental resistance of a shingle on a roof. Even with the advent of acrylic/polyol and starch grafted acrylic styrene based resins used in non-wovens for shingles, the non-woven must pass the same mechanical property tests as shingles made with urea formaldehyde resin. Unfortunately, acrylic/polyol, for example, if incompletely cured, is even less water resistant than urea formaldehyde.

The hydrophobic additive of the present invention, such as Aquesize® brand hydrophobic emulsion (Solv Inc.), is a waterborne stearylated acrylic which includes added self crossed-linking functionality which allows it to bond with acrylic/polyol binders during curing. It has been further determined that just 10% Aquesize® emulsion added to 90% Aquaset® 100 acrylic/polyol or starch grafted acrylic styrene proved critical in experiments to establish the highest contact angle for the lowest amount of additive. The stearyl group is hydrophobic and its presence improves the moisture resistance of the binder and thus, its hot wet tensile strength. The same concept works for other reactive hydrophobic additives, such as epoxidized soybean oil.

This invention also relates to novel binder chemistries based upon polyvinyl acetate as well as the starch grafted binders, in general. The advantages of these resins are that they are less expensive, and are potentially much easier to process in the plant than the acrylics (lower reaction temperatures, less corrosive pH, etc).

More specifically, these include externally cross-linked starch grafted styrene and externally cross-linked acrylic modified polyvinyl acetate. The use of the disclosed approaches yields glass mat with critical properties suitable for roofing shingle reinforcement, and allows for a greater process window relative to the conventional acrylic/polyol binders now commercially available.

### BRIEF DESCRIPTION OF THE DRAWINGS

The accompanying drawings illustrate preferred embodiments of the invention as well as other information pertinent to the disclosure, in which:

FIG. 1: is a bar chart graphical depiction of non-woven glass fiber hand sheets containing FF acrylic, without hydrophobic additive, compared to hypothetical hand sheets having UF minimum and maximum dry-tensile strength (lb) measurements;

FIG. 2: is a bar chart graphical depiction of non-woven glass fiber hand sheets made with FF acrylic binder, without hydrophobic additive, compared with hypothetical hand sheets having UF minimum and maximum-tear strength (gram) measurements;

FIG. 3: is a bar chart graphical depiction of non-woven glass fiber hand sheets made with FF acrylic binder, without hydrophobic additive, compared with hypothetical hand sheets having UF minimum and maximum % retention hot wet strength measurements;

FIG. 4: is a graphical depiction of hot wet retention versus various binders used on non-woven glass fiber hand sheets;

FIG. 5: is a graphical depiction of hot wet retention of non-woven glass fiber hand sheets using various binders and binder curing temperatures of 200° C. and 220° C.;

FIG. 6: is a side diagrammatic view of a preferred shingle;

FIG. 7: is a preferred embodiment of an air filter of this invention;

FIG. 8: represents preferred embodiments of drywall tape using the laid strand scrim and non-woven tape embodiments of this invention;

FIG. 9: is a cementitious board faced with the non-woven embodiment of the present invention;

FIG. 10 is a graphical depiction of formaldehyde free shingle two hour tear results (95% CI for the mean) for shingle samples employing non-wovens including various binders; and

FIG. 11 is a graphical depiction of formaldehyde free resin composition with % Aquesize 514 vs. angle shown.

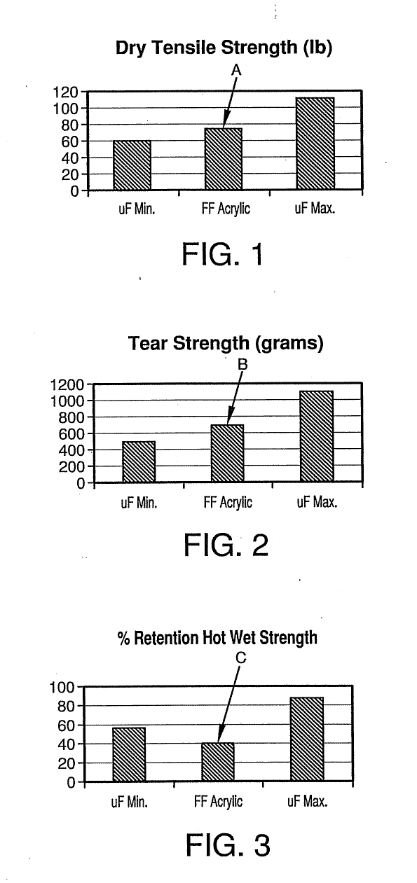

### DETAILED DESCRIPTION OF THE INVENTION

The present invention relates to glass mats or fabrics for use in building construction applications. The glass mats include chopped glass fibers and a formaldehyde-free, curable binder disposed on the glass fibers. In a first embodiment, the binder preferably includes a catalyzed polyorganic acid-polyol binder composition containing a sufficient amount of a hydrophobic additive to improve the hot wet retention of the mat by at least about 5% after five minutes of exposure to 80° C. water.

Formaldehyde-free binders such as acrylic binder, styrene acrylonitrile binder, styrene butadiene rubber binder, polyvinyl acetate binder, vinyl acrylic binder, polyurethane binder, starch grafted styrene acrylate, acrylic modified polyvinyl acetate, and combinations thereof, are useful in connection with the glass mats or fabrics of this invention. The binders may be formed as a “one-part package” in which the binder is pre-mixed with a modifying agent and packaged as a one component system, or a “two-part package” in which the binder and the modifying agent are not pre-mixed.

The preferred hydrophobic additive of this embodiment comprises a reactive hydrophobic additive. Such reactive hydrophobic additives include, stearylated acrylates, stearyl melamines, epoxidized fatty acid based oils, such as soybean oil, rapeseed oil, linseed oil, etc., and epoxy silanes. Less desirably, silane, siloxane or other fluorinated compounds can be employed. Preferably the reactive hydrophobic additive comprises a low pH waterborne stearyl acrylic with added self crossed-linking functionality which allows the reactive hydrophobic additive to bond with the preferred polyorganic acid-polyol binder during cure.

### Chemistry of Acrylic/Polyol

The major commercially available formaldehyde free alternatives to urea formaldehyde binders are based upon polyacrylic acid blended polyol, typically triethanol amine. The chemistry of the curing reaction is depicted below:

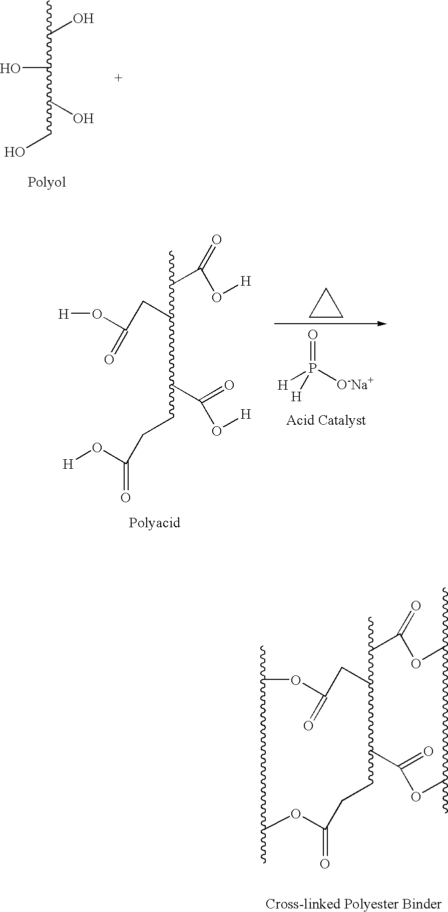

This invention discloses using hydrophobic additives that, preferably, react during the curing reaction with the binder to yield a non-woven mat with improved resistance to moisture in comparison to the standard acrylic/polyol binder chemistry. The reactive hydrophobic additives include, but are not limited to, stearyl acrylates, stearyl melamines, epoxidized fatty acid based oils such as soybean, and epoxy silanes.

### Chemistry of Starch Grafted Styrene Acrylates and Acrylic Modified PVA

In another embodiment of this invention the low pH and high temperature curing acrylic polyol chemistry is replaced by a hydrophobic styrene acrylate grafted with starch. The neutral to slightly basic pH of this binder is an improvement over the low pH acrylic polyol chemistry in that there is less risk for corrosion of production line equipment in the glass mat plant over time. This pH range also allows the use of a broader range of additives and cross-link chemistries that are not stable in the conventional low pH acrylic binder. Among these cross-linker chemistries, facilitated by the neutral pH conditions, there are several examples that react during the curing reactions at lower temperatures than the acrylic polyol chemistry. The lower reaction temperature potentially allows for faster line speeds and lower oven temperatures in the plant resulting in larger process windows and lower cost of manufacturing. One example of chemistry affording lower temperature curing of the starch grafted styrene acrylate is depicted below.

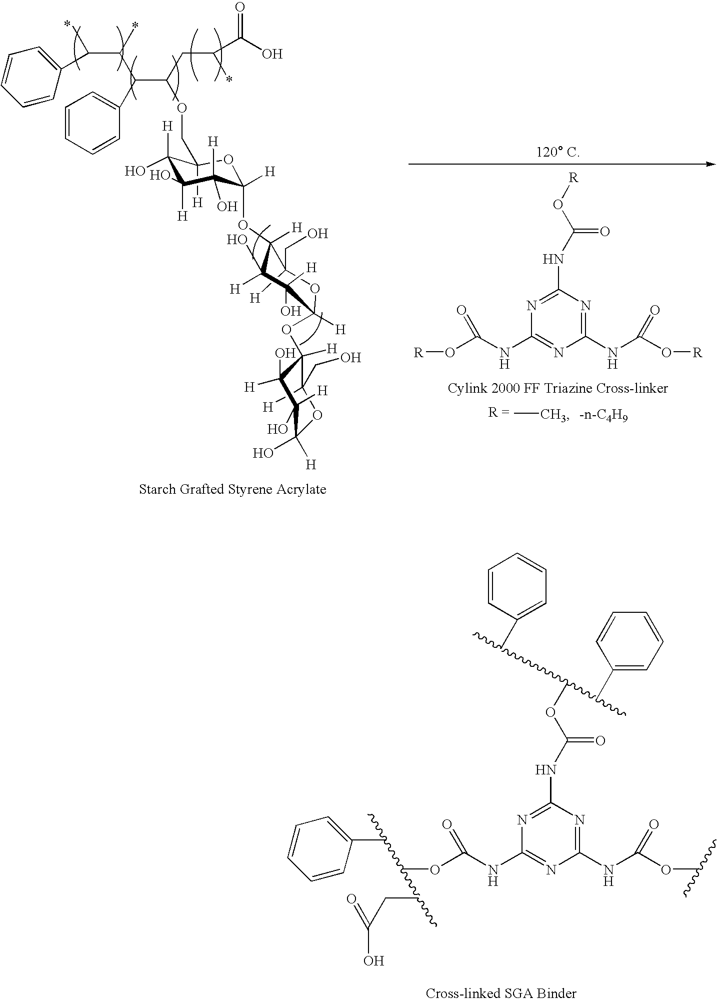

In another embodiment of the invention a neutral to mildly basic acrylic modified polyvinyl acetate is used as a non-woven binder. The same advantage for pH is gained for this binder along with the relatively low cost of this raw material. This binder can be formulated with cross-link chemistry that cures through the acrylic acid functionality. Additionally reactive hydrophobic additives can be added to improve hot wet retention of the resulting non-woven glass mat. An example of the PVA-acrylate chemistry is depicted below.

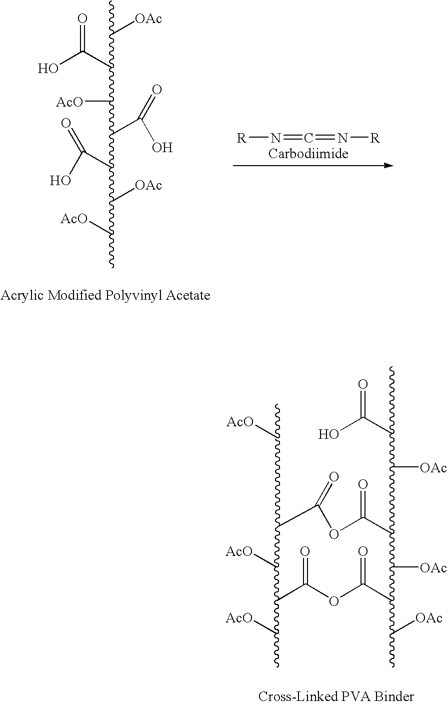

Among the reactive hydrophobic additives that can be used with the starch grafted acrylic chemistry as well as the acrylic modified polyvinyl acetate binders are epoxidized fatty acids (soybean oil, rapeseed oil, linseed oil, etc), polyethylene acrylic acids (Michem Prime, Michelman), stearylated acrylates (Aquesize 914, Solv), emulsified asphalt or coal tar based resins, hydrophobic acrylics (Lubritan S P, Rohm and Haas), and maleated PE or PP waxes. Another benefit of the addition of hydrophobic reactive additives that are organic based (as opposed to silane, siloxane, or fluorinated compounds, which are not), is increased compatibility of the binder with the molten asphalt used in shingle preparation. Increased compatibility between the reinforcement mat and the asphalt leads to higher tear strength for the shingle product.

External cross-linkers for the starch grafted monomer chemistry include reagents that effectively cross-link polyol functionality such as TACT triazine cross-linker (e.g., Cylink 2000, Cytec), epoxy silanes (e.g., Coat-O-1770, GE Silicones), zirconium ammonium carbonate (e.g., Eka AZC 5880LN, Eka), glyoxal (e.g., Eka RC5550, Eka), water dispersed blocked isocyanates (e.g., API-BI792, Advanced Polymer Inc.), water dispersable epoxies (e.g., API-EC11, Advanced Polymer Inc.), water dispersable isocyanates (Desmodur DA-L, Bayer), and polyamidoamide epichlorohydrin resins (Kymene® 557 H, Hercules).

External cross-linkers for the acrylic acid modified polyvinyl acetate binder chemistry include reagents that react with the carboxylic acid functionality such as carbodiimides (e.g., XR5580, Stahl) aziridines (e.g., Xama 7, Noveon), water dispersable epoxies and epoxy silanes, water dispersed oxazoline (e.g., APR-500, Advanced Polymer, Inc.), and polyamidoamide epichlorohydrin resins (Kymene® 557 H, Hercules).

The preferred binder composition, including its catalyzed polyorganic acid-polyol binder and preferred reactive hydrophobic additive, resist substantial degradation when exposed to molten asphalt in a temperature range of about 150-250° C. The binder composition can be cured at a temperature of about 175-250° C., more preferably about 200-220° C. Experiments were conducted herein at 200° C. and 222° C. cure temperatures.

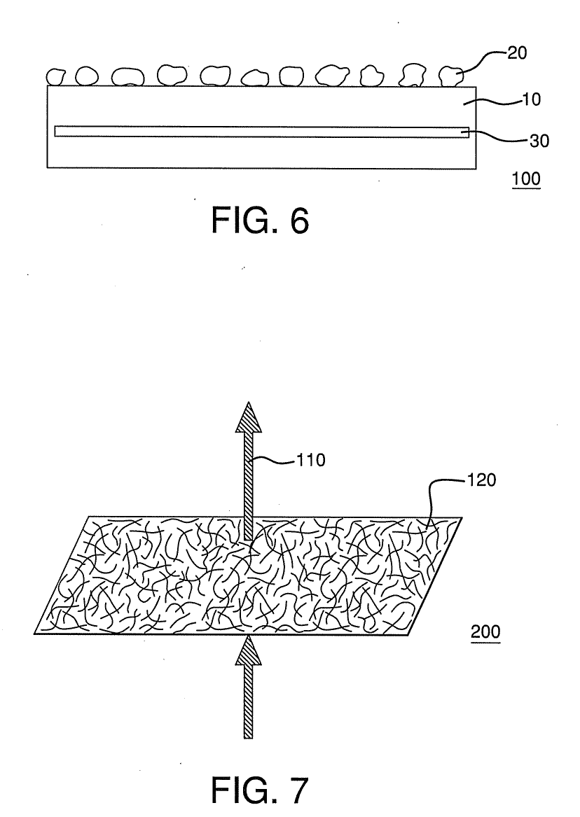

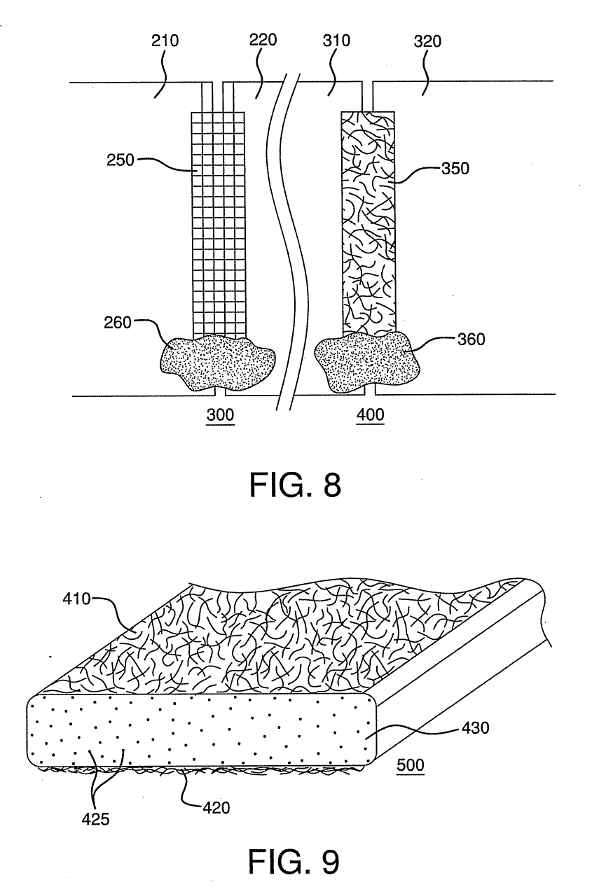

In reference to the figures, and particularly FIGS. 6-9, there are shown various end use applications for the preferred glass mat of the present invention. In accordance with FIG. 6, there is shown a roofing shingle 100 comprising an asphalt composition matrix 10 reinforced with a non-woven glass mat 30 and a layer of mineral-containing granules 20 adhered to the top surface of the asphalt composition matrix 10. The non-woven glass mat 30 comprises a formaldehyde-free, curable binder composition including polyorganic acid-polyol binder comprising a sufficient amount of a hydrophobic additive to improve the hot wet retention of said mat by at least 5% after five minutes of exposure to 80° C. water. Preferably, the hot wet retention is at least about 50% and, more preferably, greater than 60%.

To form a roofing shingle 100, asphalt is applied to the non-woven glass mat 30, such as by spraying the asphalt 10 into one or both sides of the mat 30, or by passing the mat 30 through a bath of molten asphalt to place a layer of asphalt 10 on both sides of the non-woven glass mat 30 to fill in the interstices between the individual glass filaments. The hot asphalt-coated mat may then be passed beneath one or more granule applicators which apply protective surface granules, such as ceramic coated mineral-containing granules 20, to portions of the asphalt-coated mat prior to cutting into a desired shape. The coated mat is then cut to an appropriate shape and size to form a shingle 100. The application of the asphalt 10 to the non-woven glass mat 30 may be conducted in-line with a wet-laid mat-forming process line or in a separate processing line.

It is to be appreciated that the preferred reactive hydrophobic additive such as low pH waterborne stearyl acrylic may be added to the non-woven glass mat via the two-part binder composition and/or via adding the hydrophobic additive to the same non-woven mat independent of the binder composition by separate applicator. Alternatively, the hydrophobic additive may be added to the white water alone or in addition to adding it to the two-part binder composition. It is believed that the hot wet tensile strength retention performance of the chopped strand mat correlates to the performance of the shingle, and may indicate improved lifetime performance for the shingle.

The glass fibers used to form the non-woven glass mats of the present invention may be any type of glass fiber, such as A-type glass fibers, C-type glass fibers, E-type glass fibers, S-type glass fibers, E-CR-type glass fibers, wool glass fibers, or combinations thereof. Wet use chopped strand glass fibers may also be conventionally used and should have a moisture content of about 5-30 wt. %, and more preferably, about 5-15 wt. %.

The use of other reinforcing fibers such as mineral fibers, carbon fibers, ceramic fibers, natural fibers, and/or synthetic fibers such as polyester, polyethylene, polyethylene terephthalate, polyolefin, and/or any non-woven glass mats of the present invention is within its desired scope.

The glass fibers may be formed from conventional methods known to those of ordinary skill in the art, for example, the glass fibers may be formed by attenuating streams of molten glass material from a bushing or orifice. The attenuated glass fibers may have diameters of about 5-30 microns, preferably about 10-20 microns. After the glass fibers are drawn from the bushing, an aqueous sizing composition is applied to the fibers. The sizing may be applied by conventional methods such as by an application roller or by spraying the size directly on to the fibers. The size protects the glass fibers from breaking during subsequent processing, helps to retard interfilament abrasion, and insures an integrity of the strands of glass.

With reference to FIG. 7, there is shown a filter, or media filter, which can also be used to filter gases or liquids, for example. Air 110 can pass through the filter and trapped dust particles will accumulate on the initial contact surface. The preferred air filter 200 includes a plurality of trapped glass fibers 120 bound by the binder compositions of this invention.

Similarly, a non-woven tape 350 can be fabricated for use in drywall applications. Such applications typically involve adjacent drywall boards 310 and 320 mounted to steel or wooden studs. The tape 350 can be applied to a seam between the drywall boards 310 and 320. The tape 350 can have an adhesive backing containing a pressure-sensitive adhesive. After application of the tape 350, a gypsum spackle 360 can be applied over the tape to prepare the joint 400 for finishing.

Alternatively, a joint 300 can be prepared using a laid scrim tape 250 which includes oriented strands of glass fiber bound with the preferred binders of the present invention. Woven strands could also be employed. The laid scrim tape 250 also includes a pressure-sensitive adhesive in the preferred embodiment for joining to a seam between two wall boards 210 and 220. Following application of the laid scrim tape 250, a gypsum-based joint compound 260 can be applied over the tape 250.

Finally, the glass mats of the present invention can be used in cementitious boards, such as gypsum or cement boards 500. Such cementitious boards 500 can include one or two facings 410 and 420 made from the heat-resisting glass mat, including formaldehyde-free durable binders and hydrophobic additives. The boards include a cementitious matrix 430, and optional additives, such as water-resistant additives or fire-resistant additives.

### Chemistry of Acrylic/Polyol

The major commercially available formaldehyde free alternatives to urea formaldehyde binders are based upon polyacrylic acid blended polyol, typically triethanol amine.

This invention discloses using hydrophobic additives that preferably react during the curing reaction with the binder to yield a non-woven mat with improved resistance to moisture in comparison to the standard acrylic/polyol binder chemistry. The reactive hydrophobic additives include, but are not limited to, stearyl acrylates, stearyl melamines, epoxidized fatty acid based oils such as soybean, and epoxy silanes.

### EXAMPLE A

Non-woven glass fiber hand sheets were prepared to test the effect of reactive hydrophobic additives in FF binder compositions. A 30 gallon mixing tank fitted with a mechanical stirrer was filled with 110 L of 100° F. water. The stirrer was set to 1800 rpm and 4.70 g of polyacrylamide thickener (Optimer 9901, Nalco) was added and allowed to completely disperse for 1-1.5 hrs. To the thickened solution, 94.1 g of Shercopol DS 140 ethoxylated alkyl amine anionic surfactant (Lubrizol) was added with stirring and allowed to completely disperse for 1 hour. To this solution, 55 g of mineral oil based defoamer (Foamtrol AF300, G E Betz) was added with stirring. Nine liters of the resulting white water solution was then pumped to a 10 gallon stainless steel mixing tank with 4 internal flanges and conical bottom fitted with a mechanical stirrer equipped with a stainless steel impeller designed for fiber dispersion. The stirrer was set to 1800 rpm and 7.64 g of 1 ⅜″ chopped glass M fiber (Owens Corning) was added and dispersed for 5 minutes. A ball valve at the bottom of the tank was then opened and the slurry was poured into a 12″×12″ stainless steel Williams Sheet mold with 1 inch of standing water on the bottom over a removable porous nylon mat. The valve on the sheet mold was then opened and the slurry allowed to drain. The nylon mat covered with the wet fiber was then removed from the sheet mold and the added excess white water was removed via a vacuum table fitted with a vacuum slit over which the mat was pulled via a motor and chain.

### Making of Mat Hand Sheets

Acrylic Polyol Example: A 20% solids binder solution was prepared by adding 719.17 g of Aquaset 100 (acid catalyzed self cross-linking acrylic/polyol, Rohm and Haas) to 592 g of white water solution (preparation described above), and 125 g of Aquesize 514 (hydrophobic emulsion, Solv Inc.) with magnetic stirring. This solution was evenly applied to the chopped fiber mat (described above). The excess was removed using the vacuum table. The uncured mat was placed on a stainless steel wire mesh frame and cured via forced air from the top direction using a Mini-Dryer R-3 textile oven manufactured by Gate Vaduz A G. The sample was cured at 200° C. for 3 minutes. The target LOI (loss on ignition) was about 5-35% and, more preferably, about 10-20% for a 1.8 lb/100 sq. ft. mat.

Acrylic Polyol Example with Epoxidized Soybean Oil: the epoxidized soybean oil (Vikoflex 1170, ATOFINA (Arkema)) was added to Span 60 (Uniqema) and Tween 40 (Uniqema) emulsifiers in a ratio of 40 g to 1.54 g to 1.54 g, respectively. This mixture was added to 56.6 g of white water with mechanical stirring. To male the 20% solids binder, 30 g of the resulting waterborne epoxidized soybean emulsion was added to 90.57 g of Aquaset 100 and 179.43 g of white water. The mat was prepared and cured at 200° C. by the same procedure used in Example 1.

Starch Grafted Acrylic Styrene Example: A 20% solids binder solution was prepared by adding 135.26 g of SGA-29 (starch grafted styrene acrylate, Solv. Inc) to 162.31 g of white water followed by 2.43 g of Cylink 2000 (Triazine cross-linker, Cytec Inc). The mat was prepared as described in example 1 and cured @ 190 C for 3 minutes.

Acrylic Modified Polyvinyl Acetate Example: A 20% solids binder solution was prepared by adding of 120 g of Resyn 51801-152 (Experimental Celanese PVA-acrylate) to 168 g of white water along with 6 g of Aquesize 914 (reactive stearyl modified hydrophobic additive, Solv, Inc) and 6 g of XR-5580 (carbodiimide cross-linker, Stahl). The mat was prepared as described in example 1 and cured @ 190 C for 3 minutes.

### Dry Tensile Testing Procedure

Mat hand sheet samples were cut into a minimum of three 3″×9″ pieces and measured on a tensile testing machine, with 3″ wide grips set apart 7 1/64″, at 2″/min cross head speed. The resulting tensile strength is the average of the samples in lb per 3 inch width.

### Hot Wet Retention Tensile Testing Procedure

Samples are cut in the same manner as for the dry tensile test and immersed in a controlled temperature water bath set 80° C. for 10 minutes. The samples are quickly blotted to remove excess liquid and tensile tested within 3 minutes by the procedure described above. The percent wet retention is recorded as the hot wet tensile strength divided by the dry tensile strength×100%.

Depicted in FIG. 5 are the resulting hot wet retention values after 200 and 250° C. cures of two examples of self cross-linking acrylics (Aquaset 100 and Aquaset 600, Rohm and Haas) with and without Aquesize 514 (Solve Inc.) reactive hydrophobic additive.

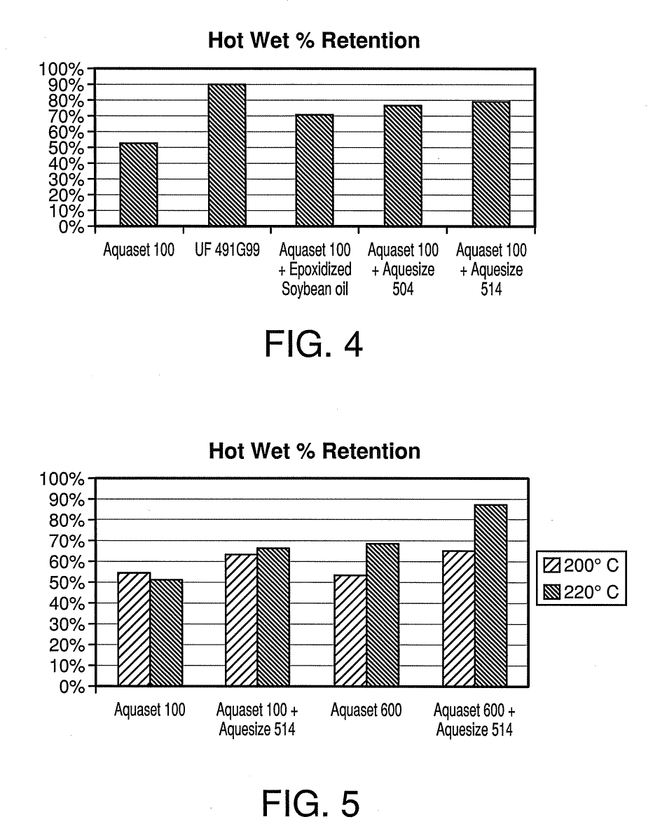

Depicted in FIG. 4 are the hot wet retention values of hand sheets prepared with hydrophobic additives in two examples (Aquaset 100+Aquesize 504; and Aquaset 100+Aquesize 514)versus a urea-formaldehyde and Aquaset 100 control.

### Glass Mat Production Example

On a non-woven mat production line equipped with a honeycomb style forced air oven, the acrylic/polyol+Aquesize 514 binder formulation using the same proportions as outlined in Example A was used to prepare 1.8 lb/100 sq. ft basis weight mat at 16.8% LOI using an exit web temperature of 200° C. The resulting mat had properties as listed below:

| | MD | CD | MD | | | |
|---|---|---|---|---|---|---|
| TYPE | TENSILE | TENSILE | TEAR | CD TEAR | LOI | RETENTION |
| Aquaset 100 + | 76 lb | 43.4 lb | 462.67 g | 727 g | 16.8% | 52.5% |
| Aquesize 514 | | | | | | |

### Shingle Production Example

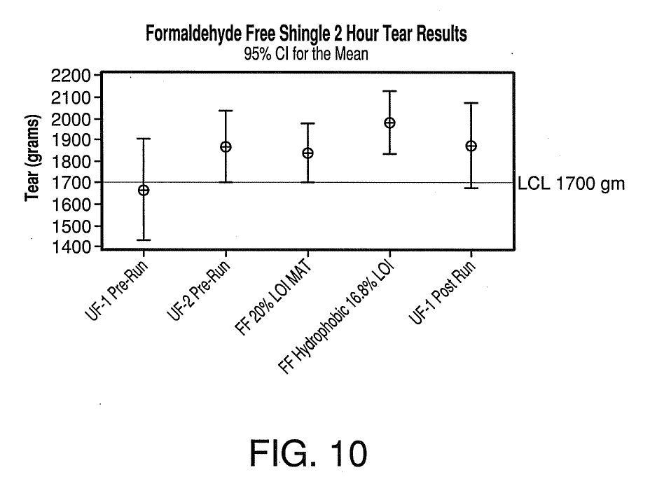

The mat described in the glass mat production example above was run on the roofing shingle production line using the standard settings and line speed used routinely for urea formaldehyde based glass mat. The two hour tear test results as per ASTM D3462 are tabulated below in FIG. 10 versus standard urea-formaldehyde control mat and a 20% LOI mat prepared with Aquaset 100 without hydrophobic additive. The lower control limit is 1700 g.

### Contact Angle Criticality Example

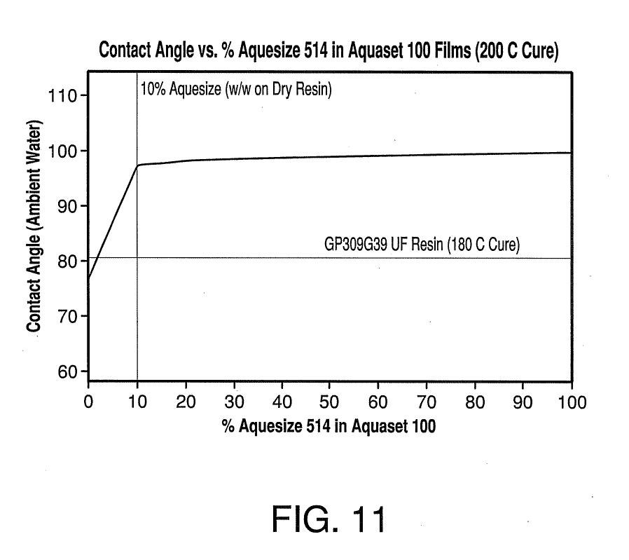

A series of experiments were conducted to try and determine the optimal amount of Aquesize 514 hydrophobic emulsion to add to Aquaset 100 acrylic/polyol. A series of films were cast and cured at 200° C., for 3 minutes using varying ratios of Aquesize 514 to Aquaset 100. The static contact angle was then measured using an AST Products VCA (Video Contact Angle) Instrument, Model# 2500XE, with water at ambient temperature. The results were compared to a urea formaldehyde based binder cured at 180° C. for 3 minutes. These cure temperatures are typical for both of these chemistries. As per the graph in FIG. 11, the formulation based upon about 10% Aquesize 514 hydrophobic additive to 90% Aquaset 100 (w/w on dry resin) exhibits the highest contact angle (most hydrophobic) at the lowest % additive.

Following 10% Aquesize, the graph of FIG. 11 levels off and plateaus, indicating a critical range of at least about 10% hydrophobic emulsion/additive for optimal wetting contact angle properties. The graph of FIG. 11 was generated by Minitab software and is a smoothed plot of the data (lowess smoother: degree of smoothing=0.75, number of steps=2).

1. A glass mat for use in building construction applications comprising:
chopped glass fibers; and
a formaldehyde-free, curable binder disposed on said glass fibers comprising a starch grafted acrylic styrene binder composition containing a sufficient amount of a hydrophobic additive to improve the hot wet retention of said mat by at least about 5% after five minutes of exposure to 80° C. water.

2. The glass mat of claim 1 wherein said hydrophobic additive comprises a reactive hydrophobic additive.

3. The glass mat of claim 2 wherein said reactive hydrophobic additive comprises one or more of stearylated acrylates, stearyl melamines, polyethylene acrylic acids, emulsified asphalt-based resin, coal tar-based resin, hydrophobic acrylics, maleated PE or PP waxes epoxidized fatty acid based oils, and epoxy silanes.

4. The glass mat of claim 2 further comprising a reagent with cross-link polyol functionality.

5. The glass mat of claim 1 wherein said starch grafted acrylic styrene binder is added to a target LOI of about 5-35%.

6. The glass mat of claim 1 wherein said binder composition, following curing, resists substantial degradation when exposed to molten asphalt in the temperature range of about 150-250° C.

7. The glass mat of claim 1 wherein said starch grafted acrylic styrene binder composition has a pH which is neutral to slightly basic.

8. A roofing shingle comprising an asphalt composition matrix reinforced with a non-woven glass mat and a layer of mineral containing granules adhered to a top surface of said asphalt composition matrix, said non-woven glass mat comprising a formaldehyde-free, curable binder composition including starch grafted acrylic styrene binder comprising a sufficient amount of a hydrophobic additive to improve the hot wet retention of said mat after five minutes of exposure to 80° C. water by at least 5%.

9. The shingle of claim 8 wherein said hydrophobic additive comprises a reactive hydrophobic additive which binds to said starch grafted acrylic styrene binder during curing.

10. The shingle of claim 8 wherein said hydrophobic additive comprises an organic based additive which provides increased compatibility between the starch grafted acrylic styrene binder and the asphalt composition matrix.

11. A glass mat for use in building construction applications comprising:
chopped glass fibers; and
a formaldehyde-free, curable binder disposed on said glass fibers comprising a catalyzed polyorganic acid-polyol binder composition containing a sufficient amount of a hydrophobic additive to improve the hot wet retention of said mat by at least about 5% after five minutes of exposure to 80° C. water.

12. The glass mat of claim 11 wherein said hydrophobic additive comprises a reactive hydrophobic additive.

13. The glass mat of claim 12 wherein said reactive hydrophobic additive comprises one or more of stearyl acrylates, stearyl melamines, epoxidized fatty acid based oils, and epoxy silanes.

14. The glass mat of claim 12 wherein said reactive hydrophobic additive comprises a low pH waterborne stearyl acrylic with added self cross-linking functionality which allows the reactive hydrophobic additive to bond with the polyorganic acid-polyol binder during cure.

15. The glass mat of claim 11 wherein said catalyzed polyorganic acid-polyol binder is added to a target LOI of about 5-35%.

16. The glass mat of claim 11 wherein said binder composition, following curing, resists substantial degradation when exposed to molten asphalt in the temperature range of about 150-250° C.

17. The glass mat of claim 11 wherein said catalyzed polyorganic acid-polyol binder composition is cured at a temperature of about 175-250° C.

18. A roofing shingle comprising an asphalt composition matrix reinforced with a non-woven glass mat and a layer of mineral containing granules adhered to a top surface of said asphalt composition matrix, said non-woven glass mat comprising a formaldehyde-free, curable binder composition including catalyzed polyorganic acid-polyol binder comprising a sufficient amount of a hydrophobic additive to improve the hot wet retention of said mat after five minutes of exposure to 80° C. water by at least 5%.

19. The shingle of claim 18 wherein said hydrophobic additive comprises a reactive hydrophobic additive which binds to said catalyzed polyorganic acid-polyol binder during curing.

20. The shingle of claim 18 wherein said non-woven glass mat comprises chopped glass fibers.

21. The shingle of claim 18 wherein said hydrophobic additive comprises a low pH waterborne stearyl acrylic with added self cross-linking functionality which allows said low pH waterborne stearyl acrylic to bond with said catalyzed polyorganic acid-polyol during cure.

22. A method of manufacturing a roofing shingle comprising:
a) providing a heat-resistant glass mat comprising non-woven glass fibers bonded with a formaldehyde-free, curable binder comprising polyorganic acid polyol binder and a sufficient amount of a hydrophobic additive to improve the hot wet retention by at least about 5%;
b) impregnating said heat resistant glass mat within an asphalt composition in a molten state at a temperature of about 150-250° C.
c) applying mineral containing granules onto a top surface of said asphalt composition; and
d) allowing said asphalt to cool.

23. The method of claim 22 wherein said catalyzed polyorganic acid-polyol binder composition is cross-linked in the presence of a catalyst prior to contact with said asphalt in said molten state.

24. The method of claim 22 wherein said shingle is substantially formaldehyde-free.

25. A method of making a glass mat reinforcement suitable for building construction comprising:
a) disposing chopped glass fibers in an aqueous solution;
b) filtering said aqueous solution from said dispersed chopped glass fibers to form a sheet;
c) drying said sheet;
d) applying a binder to said dried sheet, said binder comprising a formaldehyde-free, curable binder comprising a polyorganic acid-polyol binder composition and a hydrophobic additive; and
e) permitting said binder to cure in the presence of a catalyst at an elevated temperature.

26. The method of claim 25 wherein said hydrophobic additive comprises a reactive hydrophobic additive which binds with said polyorganic acid-polyol binder during said curing step (e).

27. An air filter comprising the glass mat of claim 1.

28. A drywall tape comprising the glass mat of claim 1.

29. A gypsum wallboard comprising a gypsum core bonded to at last one facing comprising the glass mat of claim 1.

30. A heat-resistant glass mat comprising a formaldehyde-free, curable binder including a catalyzed polyorganic acid-polyol binder composition including a sufficient amount of a hydrophobic additive to improve the hot wet retention of said glass mat by at least about 5% when exposed to hot water at a temperature of 80° C. for at least five minutes.

31. A glass mat for use in building construction applications comprising:
chopped glass fibers; and
a formaldehyde-free, binder selected from the group consisting of: acrylic polyol, starch grafted acrylic styrene, and acrylic modified polyvinyl acetate, said binder disposed on said glass fibers to bind them together, said binder also comprising a sufficient amount of a hydrophobic additive to improve the hot wet retention of said mat by at least about 5% after 5 minutes of exposure to 80° C. water.

32. The glass mat of claim 31 wherein said hydrophobic additive comprises a reactive hydrophobic additive.

33. The glass mat of claim 32 wherein said reactive hydrophobic additive comprises one or more of stearyl acrylates, stearyl melamines, epoxidized fatty acid based oils, and epoxy silanes.

34. A formaldehyde-free, curable binder composition comprising a resinous composition selected from the group consisting of acrylic polyol, starch grafted acrylic styrene, and acrylic modified polyvinyl acetate, and no more than about 10-12% (w/w on dry resin) hydrophobic additive.

35. The binder of claim 34 wherein said hydrophobic additive comprises one or more of the group consisting of stearyl acrylates, stearyl melamines, epoxidized fatty acid based oils, and epoxy silanes.

36. A reinforcing mat comprising:
glass fibers bonded by a binder composition;
the binder composition including a formaldehyde-free binder cured with a hydrophobic additive to provide bonded glass fibers with a hot wet retention percent of dry tensile strength, in 80° C. water for five minutes duration, at least 5% greater than a hot wet retention percent of dry tensile strength provided by glass fibers bonded by the binder composition without the hydrophobic additive.

37. The reinforcing mat of claim 36 wherein the binder comprises styrene acrylate grafted with starch at slightly basic pH to near neutral pH, and wherein the additive comprises, epoxidized fatty acid (soybean oil, rapeseed oil, linseed oil), polyethylene acrylic acid, stearylated acrylate, emulsified asphalt or coal tar based resin, hydrophobic acrylic, or maleated polyethylene PE or polypropylene PP wax.

38. The reinforcing mat of claim 36 wherein the binder comprises styrene acrylate grafted with starch at slightly basic pH to near neutral pH and a cross-linker comprising, carbodiimide, aziridine, water dispersible epoxy, epoxy silane, water dispersible oxazoline, and polyamidoamide epichlorohydrin resin, and wherein the additive comprises, epoxidized fatty acid (soybean oil, rapeseed oil, linseed oil), polyethylene acrylic acid, stearylated acrylate, emulsified asphalt or coal tar based resin, hydrophobic acrylic, or maleated polyethylene PE or polypropylene PP waxes.

39. The reinforcing mat of claim 36 wherein the binder comprises acrylic acid modified polyvinyl acetate, and wherein the additive comprises, epoxidized fatty acid (soybean oil, rapeseed oil, linseed oil), polyethylene acrylic acid, stearylated acrylate, emulsified asphalt or coal tar based resin, hydrophobic acrylic, or maleated polyethylene PE or polypropylene PP wax.

40. The reinforcing mat of claim 36 wherein the binder comprises acrylic acid modified polyvinyl, and a cross-linker comprising, TACT triazine cross-linker, epoxy silane, zirconium ammonium carbonate, glyoxa, water dispersed blocked isocyanate, water dispersible epoxy, water dispersable isocyanate or polyamidoamide epichlorohydrin resin, and wherein the additive comprises, epoxidized fatty acid (soybean oil, rapeseed oil, linseed oil), polyethylene acrylic acid, stearylated acrylate, emulsified asphalt or coal tar based resin, hydrophobic acrylic, or maleated polyethylene PE or polypropylene PP wax.

41. The reinforcing mat of claim 36 wherein the binder comprises a polyacrylic acid blended polyol, and wherein the additive comprises, stearyl acrylate, stearyl melamine, epoxidized fatty acid based oil such as soybean or epoxy silane.

42. The reinforcing mat of claim 36, wherein said bonded glass fibers are combined with molten asphalt at a temperature range of 150° C.-250° C.

43. A method of making a building construction structure, comprising:
imbedding the reinforcing mat of claim 36 in a matrix composition, and hardening the matrix composition to provide a building construction structure reinforced by the reinforcing mat.

44. The method of claim 43 wherein the matrix composition comprises molten asphalt at a temperature in a range of 150° C-250° C.

45. The method of claim 43 wherein the matrix composition comprises gypsum or portland cement.
